(19) United States
(12) Patent Application Publication
(10) Pub. No.: US 2012/0194438 A1
(43) Pub. Date: Aug. 2, 2012

(54) ELECTRONIC READER WITH CHINESE PINYIN INPUT FUNCTION AND CHINESE PINYIN INPUT METHOD

(75) Inventors: WEI SONG, Shenzhen City (CN); HUI-LING HUANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/187,518

(22) Filed: Jul. 21, 2011

(30) Foreign Application Priority Data
Jan. 28, 2011 (CN) 201110031007.6

(51) Int. Cl. G06F 3/02

(52) U.S. Cl. 345/171

(57) ABSTRACT

An electronic reader includes a touch display screen receiving user inputs and displaying a keypad and a processing unit. The keypad includes a plurality of first keys and a plurality of second keys, the keypad selectively operable between a pinyin mode where the first keys display letters a to z, and a Chinese character mode where the first keys display Chinese characters. The processing unit controls the electronic reader to enter the Pinyin mode, displays an intended pinyin inputted by a user on one of the second keys, activates the keypad to enter into the Chinese character mode whereby according to the input of the pinyin and displays a plurality of possible Chinese characters on the first keys, selects and displays a intended Chinese character in an entry field. A Chinese pinyin input method is also provided.

### BACKGROUND

1. Technical Field

The present disclosure relates to electronic readers and input methods thereof and, particularly, to an electronic reader with Chinese Pinyin input function and a Chinese Pinyin input method for inputting Chinese characters.

2. Description of the Related Art

When users edit comments or notes in an electronic device, especially if inputting Chinese characters into an electronic reader, the screen of the electronic reader needs to display an letter selection area, an editing area and a Chinese character selecting area (see FIG. 1). However, because the size of the display screen for an electronic reader is limited, letters displayed in letter selection area and Chinese characters displayed in Chinese character selecting area are small or not clear, users may feel eyestrain.

### BRIEF DESCRIPTION OF THE DRAWINGS

The components of the drawings are not necessarily drawn to scale, the emphasis instead being placed upon clearly illustrating the principles of an electronic reader with Chinese Pinyin input function and a Chinese Pinyin input method. Moreover, in the drawings, like reference numerals designate corresponding parts throughout multiple views.

FIG. 1 is an interface schematic view of an exemplary embodiment of a Chinese Pinyin input method applied in an electronic device in related art.

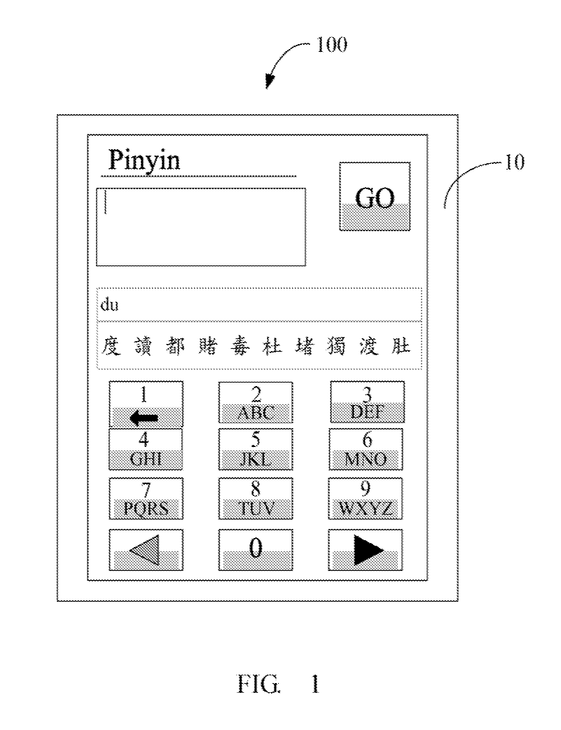

FIG. 2 is an interface schematic view of a Chinese Pinyin input method of an electronic reader in accordance with an exemplary embodiment.

FIG. 3 is a block diagram of the electronic reader of FIG. 2.

FIG. 4 is a schematic view of a pinyin combination of the electronic reader of FIG. 2.

FIG. 5 is a schematic view of updating a pinyin combination of the electronic reader of FIG. 2.

FIG. 6 is a schematic view of a Chinese character corresponding to a pinyin combination of the electronic reader of FIG. 2.

FIG. 7 is a schematic view of updating the Chinese character of FIG. 6.

FIG. 8 is a flowchart of a Chinese Pinyin input method applied in the electronic reader of FIG. 2 in accordance with an exemplary embodiment.

### DETAILED DESCRIPTION

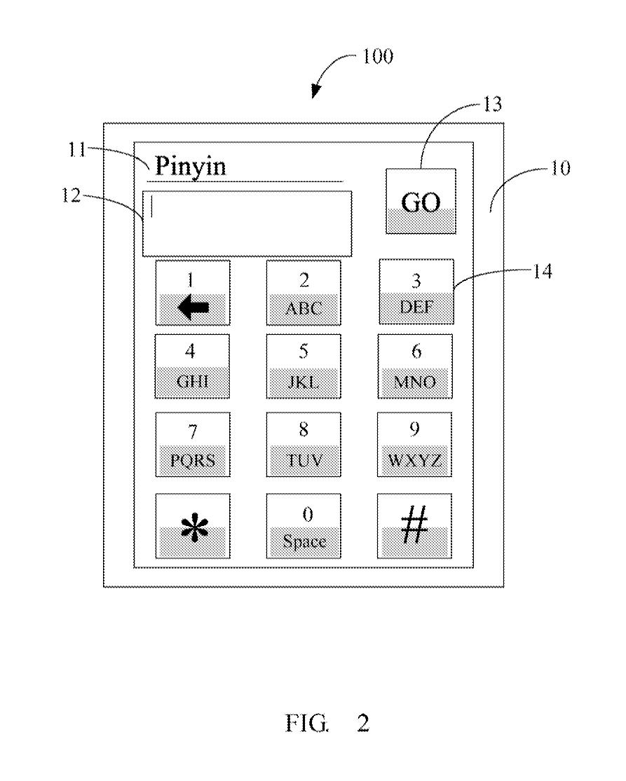

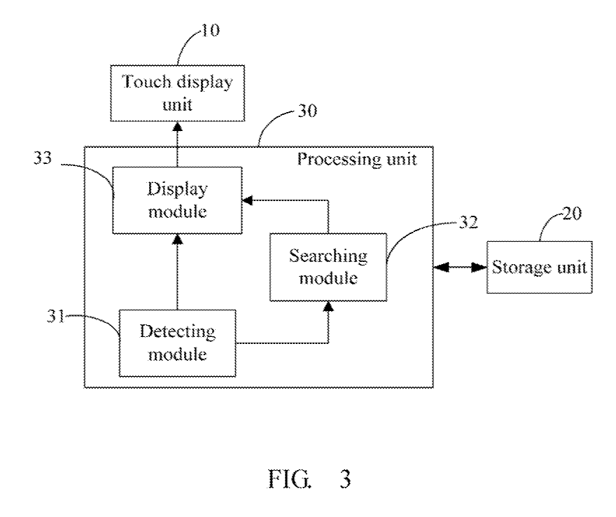

Referring to FIGS. 2 and 3, an electronic reader 100 includes a touch display unit 10, a storage unit 20, and a processing unit 30. The storage unit 20 stores character data. The character data includes 26 letters, a plurality of pinyin combinations generated by a part of the 26 letters, and Chinese characters corresponding to the pinyin combinations. The processing unit 30 controls the electronic reader 100 to enter an input mode in response to activation signals generated by a user touching the touch display unit 10 and display an editing interface on the display unit 10 under the input mode and further enters a Chinese character mode for inputting Chinese characters. The editing interface shows a keypad 14, the keypad 14 is labeled with Arabic numerals, 26 letters and symbols, and an entry field 12. The keypad 14 includes a plurality of keys. Those keys are generally multi-use keys such as for inputting letters, Chinese characters, or commands and are labeled with the letters, Chinese characters or command symbols corresponding to the use of the keys. The processing unit 30 further identifies the operation that the user applies on the touch display unit 10 and executes functions according to the operations. For example, under the Chinese Pinyin input manner, to respond to the operations that are applied by the user to the keys labeled with letters. The processing unit 30 searches the pinyin combinations corresponding to the operated keys in the storage unit 20 and displays a pinyin combination on a particular key. Then switches the pinyin combinations to display a desired pinyin combination on the particular key according to the operations of the user. The processing unit 30 further searches and displays Chinese characters or a portion of the Chinese characters corresponding to the desired pinyin combination on the particular key in response to the operations that the user applies to the keys. The processing unit 30 further displays a desired Chinese character of the Chinese characters in the entry field 12 according to the operations that the user applies to the keys and records the desired Chinese character.

An example of the editing interface is given. Excepting the entry field 12 and the keypad 14, the editing interface further includes an input mode indicator 11 for indicating a current input mode (e.g., the Chinese character mode), and a searching key 13 for activating a search based on the content in the entry field 12. The input mode indicator 11, the entry field 12 and the searching key 13 are arranged above the keypad 14.

In detail, the processing unit 30 includes a detection module 31, a searching module 32 and a display module 33. The users selects a search files option (not shown) or an add note option (not shown) to generate an activation signal of the edit mode to activate the character input. Under the edit mode, there are a plurality of types of input modes, Such as ABC input mode for inputting English uppercase letters, abc input mode for inputting English lowercase letters, Chinese character mode for inputting Chinese characters, and 123 input mode for inputting Arabic numerals. Users can further choose one of the input modes, such as the Chinese character mode and generate input key signals. Referring to FIG. 2, For example, in the keypad 14, the multi-use keys includes a number of alphanumeric keys (not labeled) containing numerals 2 through 9 and letters A through Z and a number of symbol keys (not labeled). Under the input mode, the symbol keys include a return key, a star key (*), a pound key (#) and a space key. The pound key (#) is configured to activate a “switch” function to switch among the input modes. The star key (*) is configured to activate a “display” function to display punctuation on the alphanumeric keys. The return key is configured to activate a “return” function such as returning to a previous interface or canceling an input character. The return key is also the key for inputting the number 1 and labeled with both the number “1” and an arrow. The space key is configured for inputting a space. The space key is also the key for inputting the number 0 and labeled with both the number “0” and the English word “Space”.

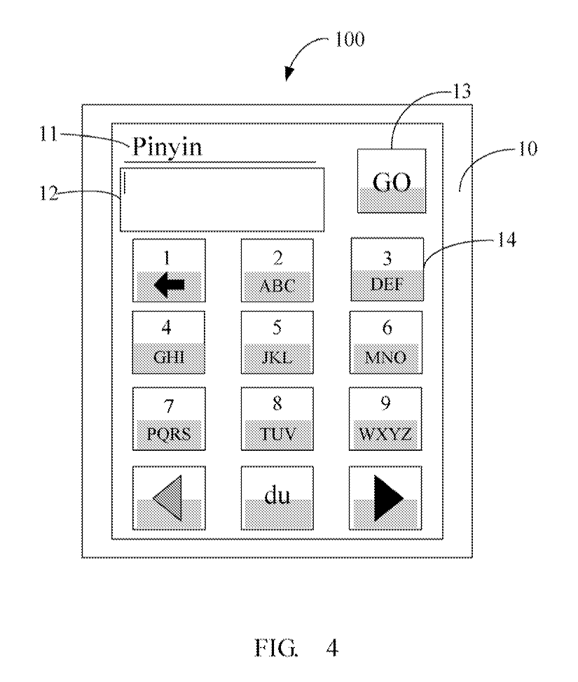

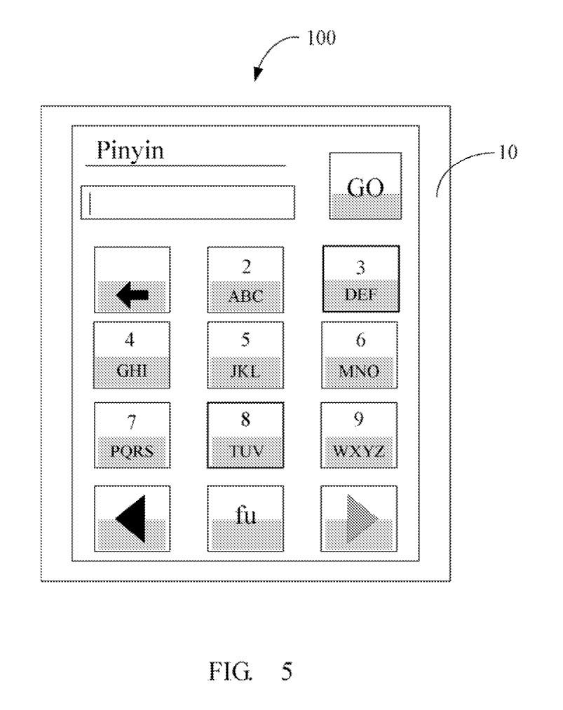

The detection module 31 transmits the activation signal to the display module 33. The display module 33 controls the touch display unit 10 to display the editing interface for inputting characters. The detection module 31 further detects a Chinese character mode signal generated by user operating the pound key (#), the display module 33 controls the electronic reader 100 to enter a Chinese character mode for inputting Chinese characters and displays “Pinyin” in the input mode indicator 11. The detection module 31 further detects the input key signals generated by user operating the alphanumeric keys under the Chinese Pinyin input manner, the searching module 32 searches pinyin combinations corresponding to the alphanumeric keys in response to the input key signals. Referring to FIGS. 4 and 5, in the example, after the user clicks one or more keys to form pinyin combinations, the star key (*) and the pound key (#) are replaced by a forward flipping key and a backward flipping key. One of the pinyin combinations is displayed on the space key. The forward flipping key and the backward flipping key are provided for activating a “switch” function to switch among the pinyin combinations to select a desired pinyin combination. In the embodiment, when a desired pinyin combination is displayed on the space key, an operation such as a click on the space key selects the desired pinyin combination.

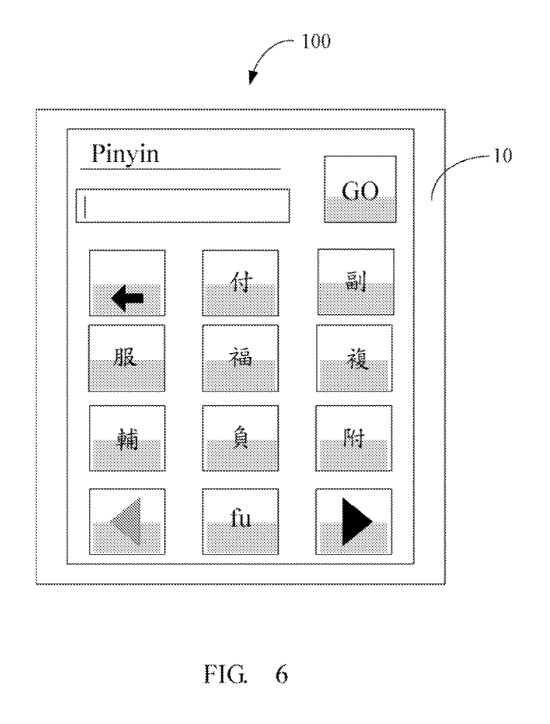

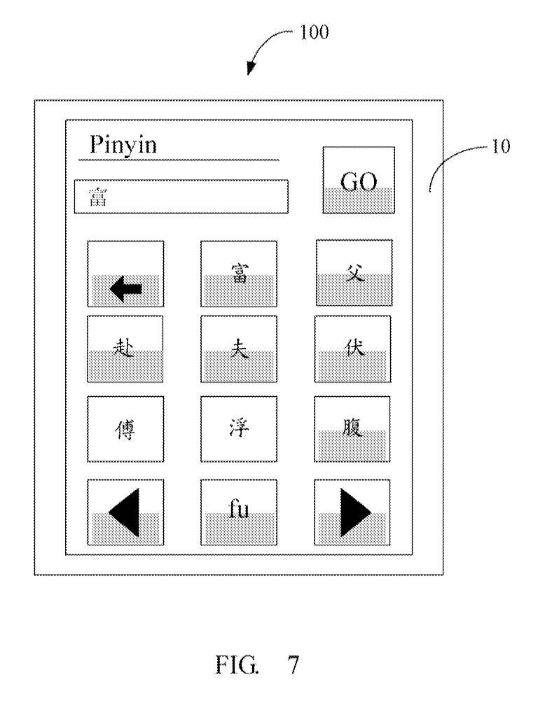

Referring to FIGS. 6 and 7, the searching module 32 searches Chinese character groups corresponding to the pinyin combinations. The display module 33 displays a Chinese character group corresponding to a desired pinyin combination on the alphanumeric keys. The Chinese characters or a portion of the Chinese characters of the Chinese character group are distributed on the alphanumeric keys. One Chinese character corresponds to one alphanumeric key and an operation such as a click on one of the alphanumeric keys, causes the input of a corresponding Chinese character. When only a portion of the Chinese characters is displayed on the alphanumeric keys, the forward flipping key and the backward flipping key are provided for activating a “switch” function to switch to another portion of the Chinese characters of the Chinese character group, so that another portion of the Chinese characters group is displayed on the alphanumeric keys. In the embodiment, when a desired Chinese character is displayed on an alphanumeric key, an operation such as a click on the alphanumeric key selects the desired Chinese character. The selected Chinese character is displayed in the entry field 12 by the display module 33. After the inputting of the Chinese character, the forward flipping key and the backward flipping key are replaced by the star key (*) and the pound key (#) correspondingly. That is, the forward flipping key and the backward flipping key appear only during the inputting of a Chinese character. When the input of the Chinese character is completed, the forward flipping key and the backward flipping key disappear and the star key (*) and the pound key (#) appear.

Furthermore, the processing unit 30 also searches a file according to the content in the entry field 12, in response to the operation such as a click on the searching key 13, and controls the display module 33 to display a search result. For example, if a user wants to search for a book and inputs the name of the book in the entry field 12. The processing unit 30 searches the book in the storage unit 20 or in other available resource corresponding to the name in the entry field 12 and controls the display unit 10 to display the home page of the book if the book is obtained.

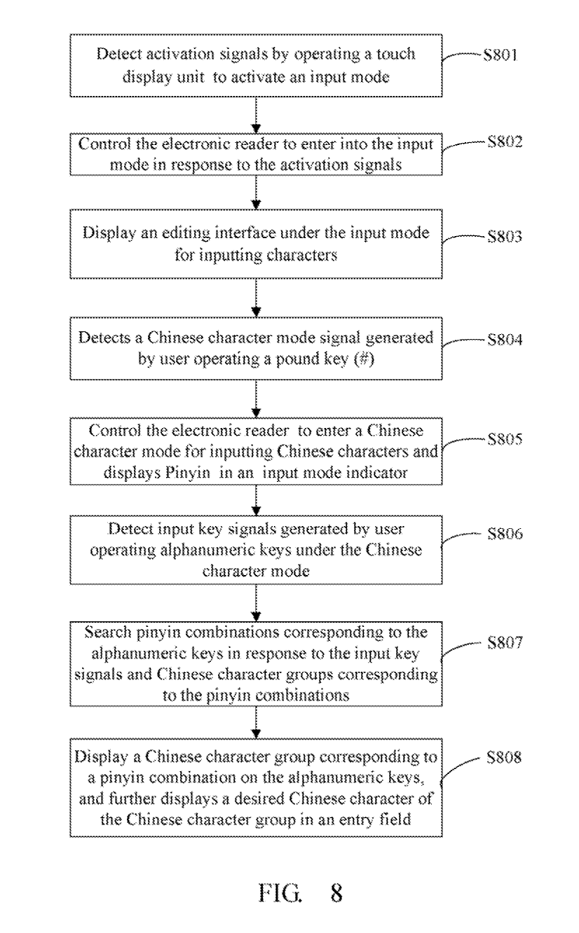

Referring to FIG. 8, a Chinese Pinyin input method applied in the electronic reader 100 in accordance with an exemplary embodiment is shown. The electronic reader 100 includes a touch display unit 10 and a processing unit 30.

In step S801, a detection module 31 of the processing unit 30 detects activation signals by operating the touch display unit 10 to activate an input mode.

In step S802, the detection module 31 controls the electronic reader 100 to enter the input mode in response to the activation signals generated by a user touching the touch display unit 10. Under the input mode, Such as ABC input mode for inputting English uppercase letters, abc input mode for inputting English lowercase letters, Chinese character mode for inputting Chinese characters, and 123 input mode for inputting Arabic numerals.

In step S803, a display module 33 controls the touch display unit 10 to display an editing interface under the input mode for inputting characters. The editing interface includes an input mode indicator 11 for indicating a selected input mode by user, an entry field 12 for inputting characters, a searching key 13 for searching the content recorded in the entry field 12, and a keypad area 14. In the keypad area 14, the keys includes a number of alphanumeric keys (not labeled) containing numerals 2 through 9 and letters A through Z and a number of symbol keys (not labeled). Under the input mode, the symbol keys include a return key, a star key (*), a pound key (#) and a space key. The pound key (#) is configured to activate a “switch” function to switch among the input modes. The star key (*) is configured to activate a “display” function to display punctuation on the alphanumeric keys. The return key is configured to activate a “return” function such as returning to a previous interface or cancelling an input character. The return key is also the key for inputting the number 1 and labeled with both the number “1” and an arrow. The space key is configured for inputting a space. The space key is also the key for inputting number 0 and labeled with both the number “0” and the English word “Space”.

In step S804, the detection module 31 further detects a Chinese character mode signal generated by user operating the pound key (#).

In step S805, the display module 33 controls the electronic reader 100 to enter a Chinese character mode for inputting Chinese characters and displays “Pinyin” in the input mode indicator 11.

In step S806, the detection module 31 further detects the input key signals generated by user operating the alphanumeric keys under the Chinese character mode.

In step S807, the searching module 32 searches pinyin combinations corresponding to the alphanumeric keys in response to the input key signals and Chinese character groups corresponding to the pinyin combinations.

In step S808, the display module 33 displays a Chinese character group corresponding to a pinyin combination on the alphanumeric keys, and further displays a desired Chinese character of the Chinese character group in the entry field 12 according to selection of the user.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic reader, comprising:
a touch display screen configured for receiving user inputs and displaying a keypad, the keypad comprising a plurality of first keys and a plurality of second keys, the keypad selectively operable between a pinyin mode where the first keys display letters a to z, and a Chinese character mode where the first keys display Chinese characters; and
a processing unit configured for:
controlling the electronic reader to enter the Pinyin mode whereby the first keys display letters a to z;
controlling the touch display screen to display an intended pinyin inputted by a user on one of the second keys;
activating the keypad to enter into the Chinese character mode whereby according to the input of the pinyin and displaying a plurality of possible Chinese characters on the first keys, the possible Chinese characters having a similar pronunciation of the inputted pinyin;
selecting a Chinese character from the possible Chinese characters displayed on the first keys in response to a touch by a user on a first key associated therewith; and
displaying the selected Chinese character in an entry field displayed on the touch display screen.

2. The electronic reader as claimed in claim 1, wherein the keypad is an alphanumeric keypad, the processing unit further is configured for sensing touch operations on the first keys by a user so as to determine a plurality of pinyin combinations associated with the touched keys and displaying one of the pinyin combinations on the second key.

3. The electronic reader as claimed in claim 1, wherein the processing unit displays other possible Chinese characters on the first keys in response to a touch by a user on another two of the second keys.

4. The electronic reader as described in claim 1, wherein the second keys comprise a switch key configured for switching the keypad into another input mode, said another input mode is selected from the group consisting of an ABC input mode for inputting English capital letters, an abc input mode for inputting English lowercase letters, or a 123 input mode for inputting Arabic numerals.

5. A Chinese pinyin input method comprising:
displaying a keypad on a touch display screen, the keypad including a plurality of first keys and a plurality of second keys, the keypad selectively operable between a pinyin mode where the first keys display letters a to z, and a Chinese character mode where the first keys display Chinese characters;
entering into the pinyin mode whereby the first keys display letters a to z;
displaying an intended pinyin inputted by a user on one of the second keys, the input of the pinyin activating the keypad to enter into the Chinese character mode whereby and a plurality of possible Chinese characters are displayed on the first keys, the possible Chinese characters having a similar pronunciation of the inputted pinyin;
selecting a Chinese character from the possible Chinese characters displayed on the first keys in response to a touch by a user on a first key associated therewith; and
displaying the selected Chinese character in an entry field displayed on the touch display screen.

6. The method as described in claim 5, wherein the keypad is an alphanumeric keypad, the intended pinyin is displayed by a process comprising:
sensing touch operations on the first keys by a user so as to determine a plurality of pinyin combinations associated with the touched keys;
displaying one of the pinyin combinations on the second key;
displaying other pinyin combinations one by one on the second key in response to touches on another two of the second keys until the intended pinyin is displayed on the second key.

7. The method as described in claim 5, further comprising displaying other possible Chinese characters on the first keys in response to a touch by a user on another two of the second keys.

8. The method as described in claim 5, wherein the second keys include a switch key configured for switching the keypad into another input mode, said another input mode is selected from the group consisting of an ABC input mode for inputting English capital letters, an abc input mode for inputting English lowercase letters, or a 123 input mode for inputting Arabic numerals.
